(19) United States
(12) Patent Application Publication
(10) Pub. No.: US 2004/0262133 A1
(43) Pub. Date: Dec. 30, 2004

(54) Article engagable unit selective positioning

(75) Inventor: Donald J. Simkowski, Loveland, CO (US)

Correspondence Address: THE LAW FIRM OF HARRIS & BURDICK, HAROLD BURDICK AND ROBERT HARRIS, 6676 GUNPARK DRIVE, SUITE E, BOULDER, CO, 80301

(73) Assignee: Goldco Industries, Inc.

(21) Appl. No.: 10/603,984

(22) Filed: Jun. 25, 2003

(51) Int. Cl. B65G 35/00

(52) U.S. Cl. 198/866

(57) ABSTRACT

An article engagable unit is selectively positioned by a positioning device and method along an engaging path. The positioning device includes a movable unit having a slider relatively movable with respect to a mounting unit by a pneumatic unit with the slider having a pawl and a connector connecting the article engagable unit for movement with the slider. A mechanical unit includes a shaped wheel and a ratchet wheel rotatable with the shaped wheel and engagable with the pawl on the slider upon movement of the slider in one direction to rotate the ratchet wheel and shaped wheel to successively move each of a plurality of stops spaced about the periphery of the shaped wheel to a stop area for engagement thereat with the slider when moved in a second direction to thereby establish a plurality of selectable set positions for the article engagable unit along the engaging path.

### FIELD OF THE INVENTION

This invention relates to article positioning and/or conveying, and, more particularly, relates to selective positioning of an article engagable unit along an engaging path for positioning and/or conveyance of articles.

### BACKGROUND OF THE INVENTION

It is oftentimes necessary to position and/or convey articles having side portions, such as, for example, containers or packages.

It is well known that such articles may be conveyed using belts and/or air in conjunction with guides or the like establishing and maintaining an article path (see, for example, U.S. Pat. No. 5,320,457 (VanderMeer et al.) and U.S. Pat. No. 5,372,472 (Winski et al.)).

Likewise, it is well known that such articles may be positioned (including while being conveyed) using, for example, pushers or guides to urge the articles a predetermined distance or into a then needed pattern (see, for example, U.S. Pat. No. 4,934,508 (VanderMeer et al.), U.S. Pat. No. 5,320,478 (Gonsowski et al.), and U.S. Pat. No. 5,372,472 (Winski et al.)).

Also, it is now known that guides or the like can be provided at a fixed position with respect to an article path (see, for example, U.S. Pat. No. 5,028,174 (Karass) and U.S. Pat. No. 6,190,094 (Rediess et al.)) or may be adjusted with respect to an article path (see, for example, (U.S. Pat. No. 5,161,919 (Smith et al.) and U.S. Pat. No. 6,293,736 (Farquhar)).

It is often desirable, however, and in some cases necessary, that article engagable elements, such as guides or pushers, have a capability for quick and reliable movement different distances depending upon the particular containers or packages to be then positioned and/or conveyed.

### SUMMARY OF THE INVENTION

This invention provides a device and method for selective positioning of an article engagable unit along an engaging path, including positioning of articles and/or facilitating conveyance of articles along an article path, with the device being reliable and capable of rapid adjustment between set positions along an engaging path, as well as being relatively simple and inexpensive.

The positioning device for the article engagable unit includes a mounting unit and a relatively movable unit, now preferably including a slider having an actuator and an article engagable unit connector as specifically shown and described herein, for positioning the article engagable unit along an engaging path.

A mechanical unit capable of establishing a plurality of set positions for the article engagable unit along the engaging path is used in conjunction with the movable unit to enable positioning of the article engagable unit at any of the plurality of set positions along the engaging path.

The mechanical unit includes first and second movable portions, now preferably a ratchet wheel and a shaped wheel constrained to common movement as specifically shown and described herein, with the first movable portion being engagable with the actuator on the movable unit and the second movable portion providing a plurality of stops, or movable stops, for establishing the plurality of set positions for the article engagable unit.

In operation, a force unit, now preferably a pneumatic unit as specifically shown and described herein, causes the movable unit to be driven in a first direction so that the actuator on the movable unit actuates the first movable portion of the mechanical unit for limited distance movement to thereby cause movement of the mechanical unit to position one stop of the plurality of stops on the second movable portion of the mechanical unit at a stop area, and thereafter causes the movable unit to be moved in a second direction to move the movable unit to the stop area to engage the stop then at the stop area to thereby position the article engagable unit at a set position along the engaging path, with repeated movement of the movable unit, if necessary, in the first and second directions causing a particular stop, then needed, to be positioned at the stop area whereby the article engagable unit can be positioned at any of the plurality of set positions along the engaging path.

It is therefore an object of this invention to provide an improved article engagable unit positioning device and method.

It is another object of this invention to provide an improved device and method for selective positioning of an article engagable unit along an engaging path for positioning of articles.

It is another object of this invention to provide an improved device and method for selective positioning of an article engagable unit along an engaging path to facilitate conveyance of articles along an article path.

It is another object of this invention to provide a positioning device and method utilizing a mechanical unit for establishing a plurality of set positions for an article engagable unit.

It is another object of this invention to provide a positioning device having a mechanical unit operating in conjunction with a movable unit for establishing and selecting a set position for an article engagable unit.

It is another object of this invention to provide a positioning device having a movable unit with an actuator and an article engagable unit connected therewith operated in conjunction with a mechanical unit having a first movable portion engagable with the actuator and a second movable portion with stops thereon to establish a plurality of set positions for the article engagable unit along an engaging path with selection of a particular one of the plurality of set positions causing the article engagable unit to be positioned at a then needed set position along the engaging path for positioning and/or conveyance of articles.

With these and oth r objects in view, which will become apparent to one skilled in the art as the description proceeds, this invention resides in the novel construction, combination, arrangement of parts, and method substantially as hereinafter described, and more particularly defined by the appended claims, it being understood that changes in the precise embodiments of the herein disclosed invention are meant to be included as come within the scope of the claims.

### BRIEF DESCRIPTION OF THE DRAWINGS

The accompanying drawings illustrate complete embodiments of the invention according to the best mode so far devised for the practical application of the principles thereof, and in which:

FIG. 1 is a first perspective view of the positioning device of this invention illustrated having an article engagable unit connected therewith;

FIG. 2 is a second perspective view of the positioning device as shown in FIG. 1;

FIG. 3 is a perspective view like that of FIG. 1 but having portions cut-away;

FIG. 4 is a third perspective view of the positioning device as shown in FIGS. 1 and 3 but having portions cut-away;

FIG. 5 illustrates, in perspective, a pair of positioning devices positioned at opposite sides of an article path; and

FIG. 6 is a simplified block diagram illustrating air control to the air cylinder of the pneumatic unit shown in FIGS. 1 through 5.

### DESCRIPTION OF THE INVENTION

Article engagable unit positioning device, or positioner, 7 of this invention may be utilized to position or guide conveyed articles having an engagable side portion, with such articles including, by way of example, containers or packages, such as bottles, boxes, cartons, or cases (including fully or partially packaged containers or packages). In addition, the article (or articles) may be positioned, or repositioned, at one location, or may be positioned to facilitate conveyance of the article (or articles) along an article path.

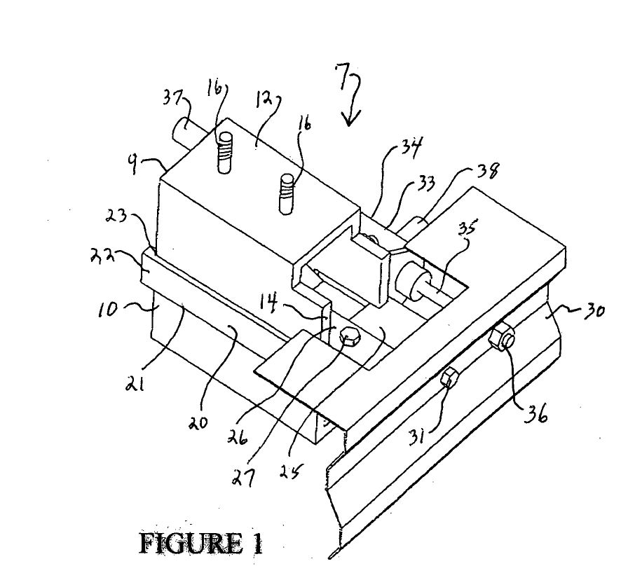

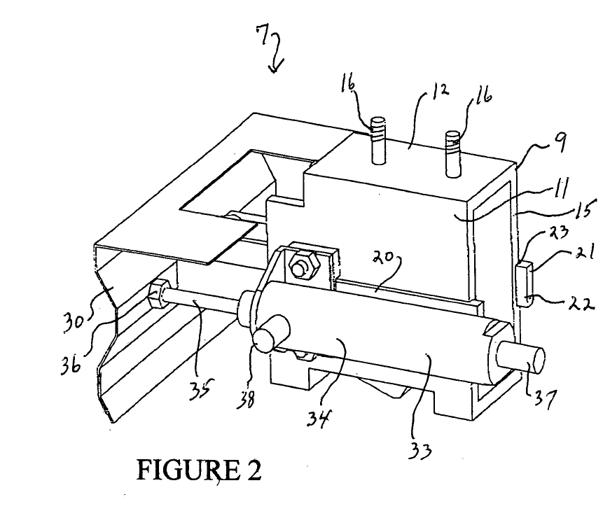

As shown in FIGS. 1 through 5, article engagable unit positioning device 7 includes a first, or mounting, unit 9 having sides 10 and 11, top and bottom walls 12 and 13, and front and back walls 14 and 15.

As indicated in FIGS. 1, 2, and 5, mounting unit 9 includes threaded mounting posts 16 to enable fastening of the mounting unit to a frame.

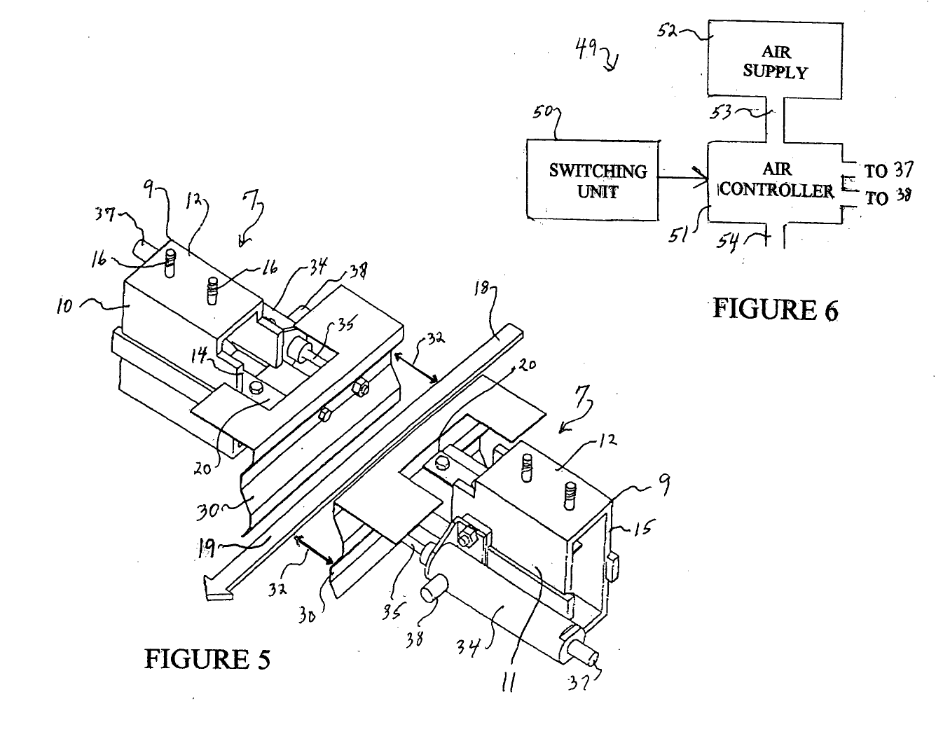

As particularly illustrated in FIG. 5, positioner 7 is positioned, by way of specific example, adjacent to article path 18 (article path 18 has a middle 19 and varies in width depending upon the articles to be conveyed along the article path).

By fastening positioner 7 to a frame that also has article supporting and/or conveying apparatus (establishing article path 18) also mounted thereon, a known relationship between the positioner and the article path is thereby established in the same manner as is established, for example, in above-cited prior art references between side guides and supporting and/or conveying apparatus.

Second, or movable, unit 20 of article engagable unit positioning device 7 includes, as best shown in FIGS. 1, 2, and 5, a slider 21 with arms 22 movably mounted in notches 23 in side walls 10 and 11 of the mounting unit so that the slider can move in opposite directions toward and away from mounting unit 9 (and toward and away from the middle of article path 18 as specifically indicated in FIG. 5).

Slider 21 also has a front block, or plate, 25 and arm 26 (fastened to front block 25 by bolts 27) that extends rearwardly into mounting unit 9.

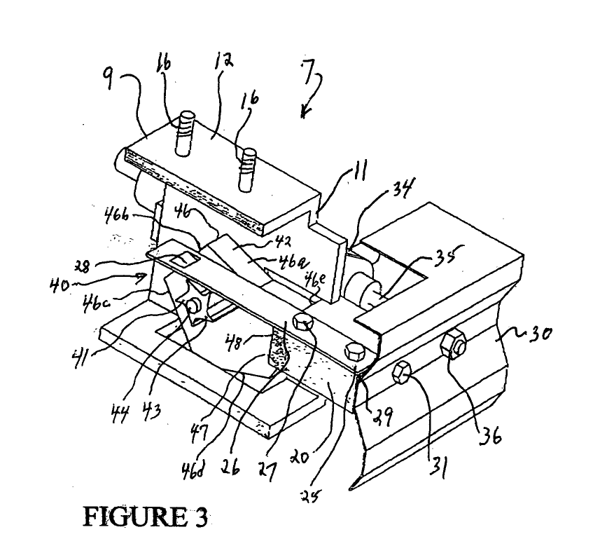

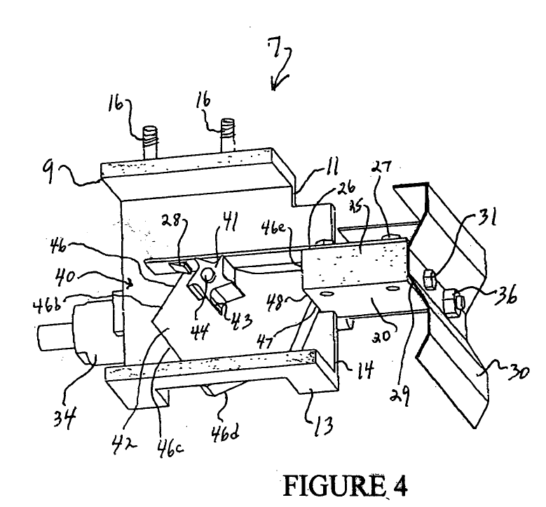

As shown in FIGS. 3 and 4, arm 26 has an actuator 28 (a pawl as indicated) thereon and block 25 has a connector, or connector portion, 29 at the front thereof so that the slider can be connected with article engagable unit 30 (by means of bolt 31 in FIGS. 1, 3, and 5) for selective positioning of article engagable unit 30 along engaging path 32 (article engagable unit 30 is specifically illustrated in FIG. 5 as an article guide, or article engagable guide, selectively positioned along a guide path as engaging path 32).

As particularly indicated in FIG. 5, article guide 30 may extend along and adjacent to article path 18 with the set positions of article guide 30 along angularly oriented (substantially perpendicular as indicated in FIG. 5) guide path 32, with respect to article path 18, so that the movement of the guide along the guide path is toward and away from the mounting unit to thereby decrease or increase the width of article path 18.

Force unit 33, now preferably a pneumatic unit as indicated in the drawings, has air cylinder 34 mounted on side 11 of the mounting unit with cylinder rod 35 extending in a forward direction from the cylinder.

As shown, rod 35 is connected with movable unit 20 and, more particularly, is connected with connector 29 of slider 21 and article engagable unit 30 (using nuts 36 as indicated in FIGS. 1 through 5) so that the movable unit is caused to be moved in first and second opposite directions toward and away from engagable articles (and thus away from and toward the mounting unit) by introduction of air into rear port 37 to cause rod 35 to be extended to effect movement of the movable unit in a first direction away from the movable unit and toward engagable articles (i.e., toward the middle of article path 18 as specifically illustrated in FIG. 5), or into front port 38 to cause rod 35 to be retracted to effect movement of the movable unit in a second direction toward the mounting unit and away from engagable articles (i.e., away from the middle of article path 18 as specifically illustrated in FIG. 5).

Mechanical unit 40 is mounted on side 10 of mounting unit 9 and, as indicated in FIGS. 3 and 4, has first and second movable portions 41 and 42 constrained to common movement with respect to one another (as specifically illustrated in FIGS. 3 and 4, and as now preferred, first movable portion 41 is a ratchet wheel having shaped teeth 43 and second movable portion 42 is a shaped wheel with both wheels being fixed to pivot pin 44 for common rotation).

As also indicated in FIGS. 3 and 4, ratchet wheel 41 is engagable with pawl 28 to cause limited rotation of the ratchet wheel (i.e., the ratchet wheel is rotated a limited distance upon each actuation by the pawl during movement of the pawl in a first, or forward, direction away from the mounting unit (i.e., toward the middle portion of article path 18 as specifically illustrated in FIG. 5) with shaped teeth 43 of the ratchet wheel assuring that a uniform distance is traveled during each actuation by the pawl.

Shaped wheel 42 has a plurality of movable stops 46 (stops 46a, 46b, 46c, 46d, and 46e as indicated in FIGS. 3 and 4) each of which can be successively positioned at stop, or block, area 47 (i.e., a different stop is positioned at stop area 47 upon each actuation of the ratchet wheel and the shaped wheel (stop 46e is illustrated in FIGS. 3 and 4 as the stop then at stop area 47).

With respect to the stops at the periphery of the shaped wheel as indicated in FIGS. 3 and 4, stop 46a is positioned at stop area 47 when cylinder rod 35 is most retracted to establish a set position with the article engagable unit extending the least distance from the mounting unit (i.e., the greatest distance from the middle of article path 18 as specifically illustrated in FIG. 5), stops 46b, 46c, and 46d are successively positioned at stop area 47 when cylinder rod 35 is progressively more extended so that the established set positions are at greater distances from the mounting unit (i.e., at lesser distances from the middle of article path 18 as specifically illustrated in FIG. 5), and stop 46e is positioned at stop area 47 with the greatest extension of cylinder rod 35 to establish a set position at the greatest distance from the mounting unit (i.e., at the least distance from the middle of article path 18 as specifically illustrated in FIG. 5).

Cylinder rod 35 when moved to maximum extension during movement of the slider in the first direction to actuate the ratchet wheel is further extended than extension of the rod when positioned with stop 46e at the stop area.

Movement of slider 21 in a second, or rearward, direction toward the mounting unit (i.e., away from article path 18 as specifically illustrated in FIG. 5) causes the pawl to be moved past the ratchet wheel without causing rotation of the ratchet wheel, and then causes rear edge 48 of front block 25 of the slider to be positioned at the stop area in engagement with the stop on the shaped wheel then positioned at the stop area to thereby establish a set position for the article engagable unit along the engaging path.

For selection of a then needed stop 46 to establish a then needed set position for the article engagable unit along the engaging path (unless that stop is then at the stop area), pawl 28 is repeatedly moved into engagement with ratchet wheel 41 (by moving slider 21 in the forward direction to engage and rotate the ratchet wheel a limited distance, after which the slider is moved in the rearward direction past the ratchet wheel before being moved in the forward direction to again engage the ratchet wheel).

Each actuation of the ratchet wheel rotates the ratchet wheel and shaped wheel a limited distance to thereby position successive ones of stops 46 at stop area 47 until the then needed stop is positioned at the stop area to thereby establish the then needed set position for the article engagable unit along the engaging path. Thus, any one of the plurality of set positions can be established for the article engagable unit along the engaging path.

Stops 46 on shaped wheel 42 are selected and formed at the periphery of the shaped wheel in view of known particular distances the article engagable unit needs to be moved to position particular articles (such as containers or packages of different size) and/or needs to be spaced to provide a sufficiently sized article path (an article path, for example, of sufficient width between positioners at opposite sides of the article path, as specifically illustrated in FIG. 5, as is then needed for articles to be then conveyed along the article path).

While five stops are illustrated in FIGS. 3 and 4, the number of stops can be varied as needed (up to about seven or eight stops being now considered as practical).

Like positioners 7 may be positioned at opposite sides of article path 18, as is specifically illustrated in FIG. 5, and like positioners 7 may likewise be positioned at different locations along the articles or the article path (at one side, or at both sides, of the articles or the article path).

Control unit 49 is preferably used to control operation of the positioning device by controlling operation of the force unit to cause movement of the movable unit in the first and second opposite directions.

As particularly indicated in FIG. 6, control unit 49 may be implemented for use in connection with a pneumatic unit by switching unit 50 (such as, for example, using a programmed computer or simply a manual push button switch) controlling operation of solenoid actuated air controller 51 to cause air from air supply 52 to be introduced through air source inlet 53 to either rear port 37 or front port 38 of air cylinder 34 (with the other of ports 37 and 38 being then connected with open, or return, outlet port 54 for air discharge from the cylinder) to cause cylinder rod 35 to be extended or retracted thereby causing movement of the movable unit in the first or second direction.

As can be appreciated from the foregoing, this invention provides an improved device and method for selective positioning of an article engagable unit along an engaging path.

What is claimed is:

1. A device for selective positioning of an article engagable unit, said device comprising:
a first unit;
a second unit relatively movable with respect to said first unit, said second unit having an actuator and connectable with the article engagable unit so that said movement of said second unit relative to said first unit causes the article engagable unit to be moved along an engaging path;
a force unit for causing said movement of said second unit relative to said first unit; and
a mechanical unit capable of establishing a plurality of set positions for the article engagable unit along said engaging path, said mechanical unit being actuated by said actuator to enable positioning of the article engagable unit at any of said plurality of set positions along said engaging path.

2. The device of claim 1 wherein the article engagable unit facilitates conveyance of articles along an article path, and wherein said engaging path is angularly oriented with respect to said article path.

3. The device of claim 1 wherein said second unit includes a slider connected with said force unit to cause movement of said slider relative to said first unit, wherein said actuator is a pawl extending from said slider, and wherein said slider has a connector for connecting the article engagable unit with said slider.

4. The device of claim 1 wherein the article engagable unit is constrained to movement with said second unit.

5. The device of claim 1 wherein said force unit is a pneumatic unit.

6. The device of claim 1 wherein said device includes a control unit for controlling operation of the device.

7. The device of claim 6 wherein said control unit causes said force unit to effect movement of said second unit in first and second directions to enable said positioning of the article engagable unit at any of said plurality of set positions along said engaging path.

8. The device of claim 1 wherein said mechanical unit has first and second movable portions with said first movable portion being engagable with said actuator and said second movable portion providing a plurality of stops for establishing said plurality of set positions for the article engagable unit.

9. The device of claim 8 wherein said first movable portion is a ratchet wheel and said second movable portion is a shaped wheel constrained to rotation with said ratchet wheel and having said plurality of stops formed thereon to thereby establish said plurality of set positions for the article engagable unit.

10. The device of claim 9 wherein said ratchet wheel and said shaped wheel are rotatively mounted on said first unit.

11. The device of claim 8 wherein said force unit causes said second unit to be driven in a first direction to cause said actuator to actuate said mechanical unit, and causes said second unit to be driven in a second direction to cause said second unit to engage one of said stops at a stop area to establish one of said set positions of said plurality of set positions for the article engagable unit.

12. The device of claim 11 wherein said force unit causes said second unit to be repeatedly driven in said first and second directions until positioned at said stop area to engage the one of said stops establishing the then desired set position for the article engagable unit.

13. A device for selective positioning of an article engagable guide to facilitate conveyance of articles along an article path, said device comprising:
a first unit;
a second unit having a slider movable with respect to said first unit, said slider having a pawl extending therefrom and a connector for connecting the article guide with said slider so that the article guide is moved along a guide path toward and away from the middle of the article path upon movement of said slider with respect to said first unit;
a force unit for causing said movement of said slider with respect to said first unit; and
a mechanical unit having a ratchet wheel and a shaped wheel constrained to rotation with said ratchet wheel, said shaped wheel being shaped to provide a plurality of stops each engagable with said slider at a stop area to thereby establish a set position for the article guide along said guide path, and said ratchet wheel being engagable with said pawl to cause rotation of said ratchet wheel and said shaped wheel to thereby provide different ones of said plurality of stops at said stop area for engagement thereat with said slider to enable positioning of the article guide at any of said plurality of set positions along said guide path.

14. The device of claim 13 wherein said ratchet wheel and said shaped wheel are rotated a limited distance upon each said engagement of said ratchet wheel with said pawl, and wherein said plurality of stops provided at said shaped wheel are spaced about the periphery of said spaced wheel to enable a different one of said plurality of stops to be provided to said stop area for engagement thereat with said slider after each said limited distance rotation of said shaped wheel.

15. The device of claim 14 wherein said force unit is a pneumatic unit causing said slider to be moved in a first direction toward the middle of the article path with said pawl engaging said ratchet wheel during said movement of said slider toward the middle of the article path to cause each said limited distance rotation of said ratchet wheel and said shaped wheel, and thereafter causing movement of said slider in a second direction away from the middle of the article path to said stop area for engagement thereat with said different one of said plurality of stops then at said stop area.

16. The device of claim 15 wherein said pneumatic unit repeatedly causes said slider to be moved toward and away from the middle of the article path until a selected one of said plurality of stops spaced about said periphery of said shaped wheel is positioned at said stop area to engage said slider thereat to thereby provide the set position then needed for articles then to be conveyed along the article path.

17. The device of claim 13 wherein the device includes a control unit for controlling operation of the device.

18. A device for selective positioning of an article guide to facilitate conveyance of articles along an article path, said device comprising:
a mounting unit adjacent to the article path;
a movable unit having a slider mounted on and relatively movable with respect to said mounting unit in first and second opposite directions, said slider having a pawl extending therefrom and a connector at the end portion for connecting the article guide with said slider so that the article guide is moved along a guide path toward and away from the middle of the article path upon movement of said slider relative to said mounting unit;
a pneumatic unit for causing movement of said slider in said first and second opposite directions;
a mechanical unit having a ratchet wheel and a shaped wheel rotatively mounted on said mounting unit with said ratchet wheel and said shaped wheel being constrained to common rotation, said ratchet wheel having shaped teeth and being engagable with said pawl so that said ratchet wheel and said shaped wheel are rotated a limited distance upon each actuation of said ratchet wheel by said pawl during said movement of said slider in said first direction, and said shaped wheel having a plurality of stops formed thereon about the periphery of said shaped wheel with a different one of said plurality of stops becoming engagable with said slider at a stop area upon each repeated limited distance rotation of said shaped wheel followed by movement of said slider in said second direction to said stop area; and
a control unit for causing said pneumatic unit to effect movement of said slider in said first and second opposite directions until a then needed one of said plurality of stops is positioned at said stop area to engage said slider thereat to thereby establish the then needed set position for the article guide.

19. The device of claim 18 wherein said device is a first device, and wherein a second device like that of said first device is utilized at the side of the article path opposite to that of the first device.

20. The device of claim 18 wherein a plurality of first and second devices are utilized along the article path, and wherein said control unit controls positioning of the article guides of the first and second devices.

21. A method for selective positioning of an article engagable unit, said method comprising:
providing a mechanical unit having movable stops capable of establishing a plurality of set positions for the article engagable unit along an engaging path;
actuating the mechanical unit to position one of the movable stops at a stop area; and
utilizing the movable stop at the stop area to position the article engagable unit at one of the plurality of set positions along the engaging path.

22. The method of claim 21 wherein said method includes providing a slider connected with the article engagable unit to position the article engagable unit along the engaging path, moving the slider in a first direction and actuating the mechanical unit during movement of the slider in the first direction to position the one of the movable stops at the stop area, and moving the slider in a second direction to engage the movable stop at the stop area to position the article engagable unit at the one of the plurality of set positions along the engaging path.

23. The method of claim 22 wherein said actuation of the mechanical unit is repeated until a then needed stop is at the stop area to establish a set position then needed for the article engagable unit along the engaging path.

24. The method of claim 22 wherein the article engagable unit facilitates conveyance of articles along an article path with movement of the slider in the first direction being toward the middle of the article path, and with Movement of the slider in the second direction being away from the middle of the article path.

25. The method of claim 22 wherein said method includes providing a pneumatic unit for moving the slider in the first and second directions.

26. A method for sel ctive positioning of an article guide to facilitate conveyance of articles along an article path, said method comprising:
providing a mechanical unit having movable stops with each of the movable stops being capable of establishing a different one of a plurality of set positions for the article guide along a guide path when positioned at a stop area;
selecting a then needed one of the plurality of set positions for the article guide along the guide path to facilitate conveyance of articles along the article path;
actuating the mechanical unit such that the movable stop then needed for the selected one of the plurality of set positions is positioned at the stop area; and
moving the article guide to the then needed set position as established by the movable stop then at the stop area.

27. The method of claim 26 wherein said method includes providing a slider connected with the article guide to position the article guide along the guide path, repeatedly moving the slider in first and second directions to repeatedly actuate the mechanical unit during movement of the slider in the first direction to position the movable stop then needed for the selected one of the plurality of set positions at the stop area, and thereafter moving the slider in the second direction to engage the needed movable stop then at the stop area to position the article guide at the then selected set position.
